(19) United States
(12) Patent Application Publication
(10) Pub. No.: US 2020/0190360 A1
(43) Pub. Date: Jun. 18, 2020

(54) PURIFICATION METHODS OF ROSINS

(71) Applicant: Ingevity South Carolina, LLC, North Charleston, SC (US)

(72) Inventors: Bing Wang, Mt. Pleasant, SC (US); Russell Fitzgerald, Mt. Pleasant, SC (US)

(21) Appl. No.: 16/711,836

(22) Filed: Dec. 12, 2019

Related U.S. Application Data
(60) Provisional application No. 62/779,032, filed on Dec. 13, 2018.

(51) Int. Cl. C09F 1/02; C09F 1/04

(52) U.S. Cl. CPC C09F 1/02; C09F 1/04

(57) ABSTRACT

Presently described are methods for performing rosin purification. The methods described herein utilize a unique solvent precipitation process that surprisingly and unexpectedly reduces the color of rosin and the sulfur and unsaponifiable contents in the rosin. The described methods are also applicable to rosin derivatives such as rosin esters and amides. Utilizing this purified rosin as raw material, rosin derivatives with much improved characteristics (color, softening point and sulfur content) can be made that would otherwise be difficult to make.

### CROSS-REFERENCE TO RELATED APPLICATION

This application claims priority to U.S. Provisional Application No. 62/779,032, filed on Dec. 13, 2018, and all the benefits accruing therefrom under 35 U.S.C. § 119, the content of which in its entirety is herein incorporated by reference.

### BACKGROUND OF THE INVENTION

### Field of the Discovery

The present disclosure relates to methods to reduce at least one of color, sulfur content, odor, impurities in rosins or a combination thereof. In certain aspects the rosins include tall oil rosins, gum rosins or wood rosins. The disclosure also provides methods of purification of rosins, and making derivatives based on these purified rosins.

### Background Information

Rosins, particularly tall oil rosins, are obtained from distillation of crude tall oil (CTO) from Kraft pulping process. During the distillation process, tall oil rosin (TOR) is separated from tall oil fatty acids (TOFA), distillated tall oil (DTO), heads, and pitch. Depending on the set up and conditions of the refinery, different quality rosins can be produced with various content of by-products.

TOR obtained from the distillation of CTO tends to be dark in color, tends to darken over time (i.e., aging), and tends to have an odor. This limits the usefulness of such resins in applications where low color and/or low odor are desirable. Impurities can originate directly from the source of wood used to obtain the TOR or can be generated during the Kraft wood pulping process. The sulfur compounds present in TOR are sulfides and mercaptans, including dimethyl sulfide (DMS), dimethyl disulfide (DMDS), hydrogen sulfide (H₂S), and methyl mercaptan (MM).

Gum rosin is normally collected from tapping pine trees. The material collected using this labor-intensive process is raw rosin, or oleoresin, which is then steam distilled to separate turpentine oil from the gum rosin. Although this process does not involve Kraft processing conditions, there are still many impurities present in the gum rosin distillate that affect the color and odor of gum rosin, thus limiting the applications of the gum rosin.

The production of wood rosin has declined steadily since 1950. It utilizes stump waste of pine trees, using distillation or solvent processes to obtain wood rosin. The impurities are similar to those in gum rosin.

Some of the major applications of rosin and rosin-based derivatives are adhesives, inks, rubbers, paper sizing, and pavement marking. All of these applications require some degree of low color and low sulfur rosins.

Previous attempts have been made to reduce the color and/or odor of rosins. For example, solvent extraction with non-polar solvents to remove non-acid impurities; esterification in the presence of activated carbon; recrystallization from polar solvents; and synthetic approaches, for example, oxidation of sulfur compounds. However, while some of the previous methods appear to improve the properties of rosin and its derivatives, they suffer from several key disadvantages, including lackluster performance, being overly cumbersome to operate or too costly to scale up. As such, there is a need for better rosin purification methods that are suitable for the industrial preparation of rosins.

### SUMMARY

Presently described are methods for performing rosin purification. The methods described herein utilize a unique solvent precipitation process that surprisingly and unexpectedly significantly reduces the color of rosin, the sulfur content, and the unsaponifiable contents in the rosin. The described methods are also applicable to rosin derivatives such as rosin esters and amides. Utilizing the described purified rosin as raw material, rosin derivatives with much improved characteristics (e.g., color, softening point, and sulfur content) can be made that would otherwise be difficult to obtain.

In an aspect, a method is disclosed for purification of a rosin comprising the steps of

a. admixing a rosin-containing composition and at least one first solvent;

b. heating the mixture to form a solution;

c. combining the solution with at least one second solvent;

d. cooling the solution from step (c); and

e. isolating a purified rosin precipitate,

wherein the purified rosin has at least one of: a Gardener color from about 1 to about 4 as measured according to ASTM D1544-04; a sulfur content of about 50 to about 500 ppm as measured according to X-ray fluorescence; an acid number equal to or greater than about 178 mg KOH/g according to ASTM D664, or a combination thereof.

In another aspect, a method for purification of a rosin is disclosed using recycled solvent, comprising the steps of

a. admixing a rosin-containing composition and a recycled solvent;

b. heating the mixture to form a solution;

c. cooling the solution from step (b); and

d. isolating a purified rosin precipitate,

wherein the purified rosin has at least one of: a Gardener color from about 1 to about 4 as measured according to ASTM D1544-04; a sulfur content of about 50 to about 500 ppm as measured by X-ray fluorescence; an acid number of equal to or greater than about 178 mg KOH/g according to ASTM D664, or a combination thereof.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### DETAILED DESCRIPTION

The present disclosure will now be described more fully hereinafter, but not all embodiments of the disclosure are shown. While the disclosure has been described with reference to exemplary embodiments, it will be understood by those skilled in the art that various changes can be made and equivalents can be substituted for elements thereof without departing from the scope of the disclosure. In addition, many modifications can be made to adapt a particular structure or material to the teachings of the disclosure without departing from the essential scope thereof.

Where a range of values is provided, it is understood that each intervening value between the upper and lower limit of that range and any other stated or intervening value in that stated range is encompassed within the invention. The upper and lower limits of these smaller ranges can independently be included in the smaller ranges is also encompassed within the invention, subject to any specifically excluded limit in the stated range. Where the stated range includes one or both of the limits, ranges excluding either both of those included limits are also included in the present disclosure.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of’ or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of’ and “consisting essentially of’ shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

### Exemplary Aspects and Embodiments

Surprisingly and unexpectedly, the inventors found that tall oil rosin can be purified using a mixture of solvents to yield a white powder with improved properties. The disclosed methods relate to the purification of rosins, including tall oil rosins; purified rosins that were obtained using the disclosed methods; modified rosins derived from purified rosins; products derived from the purified rosins; and products derived from modified rosins that were derived from the purified rosins.

As described above, prior methods for reducing color, odor and sulfur content in rosin suffer from well-known disadvantages that prevent them from implementation, including not being scalable, not being economically feasible, having a low yield, and/or involving waste stream management issues. Rosin oil is soluble in many organic solvents at room temperature, which makes it difficult to purify by precipitation, trituration, or recrystallization with high % recovery. Therefore, there is a need for a rosin purification method amenable to large-scale applications.

Thus, in an aspect, the description provides methods for purification of a rosin is disclosed comprising the steps of: (a) admixing a rosin-containing composition and at least one first solvent; (b) heating the mixture to form a solution; (c) combining the solution with at least one second solvent; (d) cooling the solution from step (c); and (e) isolating a purified rosin precipitate, wherein the purified rosin has at least one of: a Gardener color from about 1 to about 4 as measured according to ASTM D1544-04; a sulfur content of about 50 to about 500 ppm as measured according to X-ray fluorescence; an acid number equal to or greater than about 178 mg KOH/g according to ASTM D664, or a combination thereof.

In certain embodiments, the precipitated rosin powder has a Gardner color of about 1 to about 4 (neat) as determined by ASTM D1544-04 and a softening point of greater than about 85° C., preferably greater than about 90° C., more preferably, greater than about 95° C. as determined by ASTM 6090. Advantageously, quantitative recovery (100%) of the rosin acids can be achieved using the disclosed methods, while removing approximately 50% of the sulfur impurities.

In any of the aspects or embodiments described herein, the rosin-containing composition purified by the disclosed methods comprises wood rosin, gum rosin, or tall oil rosin. Rosins can contain rosin acids, dimers and high-molecular weight impurities, and sulfur impurities.

A TOR can be purified by the disclosed methods. Accordingly, in an additional aspect, the description provides method for purifying a TOR. In certain embodiments, the TOR is a distillate obtained from CTO. TOR can be a mixture of several resin acids, unsaponifiables, and sulfur impurities. Resin acids include C₂₀ mono-carboxylic acids with a core having a fused carbocyclic ring system comprising double bonds that vary in number and location. Examples of resin acids include abietic acid, neoabietic acid, pimaric acid, levopimaric acid, sandaracopimaric acid, isopimaric acid, and palustric acid. TOR can further contain dimerized resin acids and dehydroabietic acids formed during the Kraft process and distillation of CTO.

According to the methods of the present disclosure, a solution of a TOR in a first solvent is prepared. In any of the embodiments described, the first solvent is added to the TOR or, alternatively, the TOR is added to the first solvent. In certain embodiments, the TOR is miscible in the first solvent at room temperature. In additional embodiments, the TOR is partially miscible in the first solvent at room temperature and can become miscible upon agitation and/or heating of the solution. In certain additional embodiments, the first solvent comprises an organic solvent or mixture of organic solvents. In certain additional embodiments, the first solvent is an organic solvent or mixture of organic solvents.

In certain embodiments, the ratio of the first solvent to TOR is from about 10:1 to 1:1 by weight.

In certain embodiments, the solution of TOR in the first solvent is heated. In certain embodiments, the temperature of the solution is about 100° C. or less. The temperature of the solution depends on the boiling point of the first solvent. In certain embodiments, the temperature of the solution will be at or below the boiling point of the solvent. For example, when the first solvent is isopropanol, the solution can be heated to about 80° C., which is a temperature less than the boiling point of isopropanol (i.e., 82° C.). It is contemplated that the duration of heating will vary based, e.g., on the rate of dissolution of rosin in the solution. For example, in certain embodiments, the solution is heated until the rosin is dissolved in the first solvent. Advantageously, the methods do not require that the solution be heated to evaporate a volume of the solvent (e.g., evaporation of half of the first solvent) as in classic recrystallization methods.

In certain embodiments, a second solvent is added to the pre-heated solution of TOR in the first solvent. In certain embodiments, the pre-heated solution of TOR in the first solvent is added to the second solvent. In additional embodiments, the second solvent is a single solvent or comprises a mixture of two or more solvents. In certain embodiments, the second solvent comprises an organic solvent. In additional embodiments, the second solvent is an organic solvent or a mixture of two or more organic solvents.

In certain embodiments, the first solvent comprises or, in certain embodiments, is a rosin-favorable solvent. As used herein, a “rosin-favorable solvent” is used to indicate that the solvent has favorable interactions with the rosin so that the rosin is dissolved in the solvent. In any of the aspects or embodiments described herein, the methods comprise a single rosin-favorable solvent or a mixture of two or more rosin-favorable solvents. In certain embodiments, rosin-favorable solvent comprises at least one of toluene, an alcohol, such as, for example, methanol, ethanol, isopropanol, n-butanol, acetone, tetrahydrofuran, chloroform, or a combination thereof. In certain embodiments, the rosin-favorable solvent comprises isopropanol, n-butanol, or a combination thereof.

In certain embodiments, the second solvent comprises or, in certain embodiments, is a rosin-unfavorable solvent. As used herein, a “rosin-unfavorable solvent” is used to indicate that the solvent has unfavorable interactions with the rosin. In certain embodiments, the second solvent comprises a single rosin-unfavorable solvent or a mixture of rosin-unfavorable solvents. In certain embodiments, the unfavorable solvent comprises at least one of acetonitrile, benzonitrile, acrylonitrile, heptane, hexanes, petroleum ether, water, or combinations thereof. In an additional embodiment, the rosin-unfavorable solvent comprises acetonitrile.

In certain embodiments, the solution of TOR in the first solvent is removed from the heating source to cool the solution. In certain embodiments, the solution is cooled to temperatures above room temperature, for example, about 30° C. In additional embodiments, the solution is cooled to about room temperature (e.g., anywhere between about 20° C. to about 25° C.). In certain embodiments, the solution is cooled to temperatures below room temperature, for example, anywhere between about 19° C. to about −10° C.

In an additional aspect, the description provides a method for purification of a rosin comprising the steps of: (a) admixing a rosin-containing composition, at least one first solvent and at least one second solvent; (b) heating the mixture to form a solution; (c) cooling the solution from step (b); and (d) isolating a purified rosin precipitate, wherein the purified rosin has at least one of: a Gardener color from about 1 to about 4 as measured according to ASTM D1544-04; a sulfur content of about 50 to about 500 ppm as measured according to X-ray fluorescence; an acid number equal to or greater than about 178 mg KOH/g according to ASTM D664, or a combination thereof.

In certain embodiments, a single first solvent is combined with a single second solvent. In still additional embodiments, a single first solvent is combined with two or more second solvents. In certain embodiments, two or more first solvents are combined with a single second solvent. In further embodiments, two or more first solvents are combined two or more second solvents. In certain embodiments, the ratio of total solvent weight (e.g., total of first and second solvents) to the weight of TOR is from about 10:1 to 1:1.

After the solution has cooled, a precipitate comprising the purified rosin forms. The precipitate can be isolated using any method known in the art, for example decantation and/or filtration. For example, in certain embodiments, filtration is performed using gravity filtration or vacuum filtration. In additional embodiments, the filtered precipitate (filter cake) is washed with solvent, for example, a mixture of a first solvent and a second solvent; a second solvent; or a mixture of second solvents.

Drying of the precipitate can be done using any method known in the art. In certain embodiments, the precipitate is dried at room temperature exposed to air, with or without vacuum; in a vacuum oven, with or without heat; or a combination thereof.

In an additional aspect, the description provides methods for purification of a rosin, wherein a recycled solvent is used to purify the rosin. In certain embodiments, the recycled solvent is a distillate from the solvent remaining after isolation of the purified precipitate according to the methods described herein. In certain embodiments, wherein the precipitate was isolated by filtration, the recycled solvent is a distillate of the filtrate. In additional embodiments, wherein the precipitate was isolated by decantation, the recycled solvent is the mother liquor. In additional embodiments, the recycled solvent further includes the solvent used to wash the purified precipitate. In an additional embodiment, the recycled solvent is distilled from the filtrate obtained from the disclosed purification methods using a rotary evaporator.

In certain embodiments, rosins purified according to the disclosed methods display at least one of low color, low odor, higher acid number, enhancement in % palustric acid, abietic acid, and neoabietic acid (% PAN), a decrease in % dehydroabietic acid, and/or an increase in the ratio of abietic acid to dehydroabietic acid or a combination thereof, relative to unpurified rosins or rosins not purified by the described methods. For example, TOR that has not been purified has a softening point of from about 75 to about 80° C., a sulfur content of about 600 to about 800 ppm, and a Gardner color from about 5 to about 8.

In certain embodiments, rosins purified using the disclosed methods have an improved color relative to unpurified rosins or rosins not purified according to the described methods. Rosin color is quantified using the Gardner color scale, which measures the “yellowness” of the rosin. The Gardner color refers to the neat color as measured by using a spectrophotometer according to the method ASTM D1544-04 (2010).

In certain embodiments, rosins purified using the disclosed methods have a Gardner color (neat) up to about 5.0, from about 1.0 to about 4.5, from about 1.0 to about 4.0, from about 1.0 to about 3.5, from about 1.0 to about 3.3, from about 1.0 to about 2.0, from about 1.5 to about 4.0, from about 1.5 to about 3.5, from about 1.5 to about 3.0, from about 1.5 to about 2.5, from about 1.5 to about 2.0, from about 2.0 to about 4.0, from about 2.5 to about 4.0, from about 3.0 to about 4.0, from about 3.5 to about 4.0, from about 3.0 to about 4.0, or from about 3.5 to about 4.0.

For viscous rosins, the color was determined by preparing a 1:1 solution of purified rosin-containing material in a solvent (e.g., toluene or pentane) using the same method and quantified using the Gardner color scale. In certain embodiments, viscous rosins purified using the disclosed methods have a Gardner color (1:1 in toluene) up to about 5.0, from about 1.0 to about 4.5, from about 1.0 to about 4.0, from about 1.0 to about 3.5, from about 1.0 to about 3.3, from about 1.0 to about 2.0, from about 1.5 to about 4.0, from about 1.5 to about 3.5, from about 1.5 to about 3.0, from about 1.5 to about 2.5, from about 1.5 to about 2.0, from about 2.0 to about 4.0, from about 2.5 to about 4.0, from about 3.0 to about 4.0, from about 3.5 to about 4.0, from about 3.0 to about 4.0, or from about 3.5 to about 4.0.

In certain embodiments, the purified rosin obtained using the disclosed methods comprises an enhanced (higher) rosin content, as indicated by the softening point, relative to unpurified rosins and/or rosins not purified according to the described methods. In certain embodiments, the softening point is measured using a Mettler DP 90 dropping point analyzer according to ASTM D6090. In certain embodiments, the rosins purified by the disclosed methods have higher softening points than unpurified rosins and/or rosins that were not purified by the disclosed methods. In certain embodiments, the increase in the softening point can be up to about 25° C., from about 5 to about 25° C., from about 10 to about 25° C., from about 15 to about 25° C., from about 20 to about 25° C., from about 5 to about 20° C., from about 10 to about 20° C., from about 15 to about 20° C., from about 5 to about 15° C., or from about 5 to about 10° C. In certain embodiments, the rosins purified by the disclosed methods comprise an increase in softening point of greater than about 85%, greater than about 86%, greater than about 87%, greater than about 88%, greater than about 89%, greater than about 90%, greater than about 91%, greater than about 92%, greater than about 93%, greater than about 94%, or greater than about 95%.

In certain embodiments, the purified rosin obtained using the disclosed methods comprises an enhanced rosin content, as indicated by the acid number (mg KOH/g). In certain embodiments, the acid number is measured by a Metrohm auto-titrator with KOH solution according to ASTM D664. In certain embodiments, the acid number of rosins purified by the disclosed methods is equal to or greater than about 178 mg KOH/g, equal to or greater than about 179 mg KOH/g, or equal to or greater than about 180 mg KOH/g.

In certain embodiments, the purified rosin obtained by the disclosed methods comprises a lower sulfur content than rosins that have not been purified and/or than rosins that were not purified by the disclosed methods. In certain embodiments, the sulfur content can be measured using XRF. In additional embodiments, the sulfur content is from about 50 to about 600 ppm, from about 50 to about 500 ppm, from about 50 to about 400 ppm, from about 50 to about 375 ppm, from about 50 to about 350 ppm, from about 50 to about 300 ppm, from about 50 to about 250 ppm, from about 50 to about 200 ppm, from about 50 to about 150 ppm, from about 100 to about 600 ppm, from about 100 to about 500 ppm, from about 100 to about 400 ppm, from about 100 to about 375 ppm, from about 100 to about 350 ppm, from about 200 to about 600 ppm, from about 200 to about 500 ppm, from about 200 to about 400 ppm, from about 200 to about 375 ppm, from about 200 to about 350 ppm, from about 250 to about 600 ppm, from about 250 to about 500 ppm, from about 250 to about 400 ppm, from about 250 to about 450 ppm, from about 250 to about 350 ppm, from about 300 to about 600 ppm, from about 300 to about 500 ppm, from about 300 to about 400 ppm, from about 350 to about 600 ppm, from about 350 to about 500 ppm, or from about 350 to about 450 ppm.

In certain embodiments, the purified rosin obtained by the disclosed methods comprises and increased amount of palustric acid, abietic acid, and neoabietic acid as compared with rosin that has not been purified and/or rosin that was not purified using the disclosed methods. In certain embodiments, the acid enrichment is indicated by the combined weight percent of palustric acid, abietic acid, and neoabietic acid (% PAN) as determined using gel permeation chromatography (GPC). In certain embodiments, the purified rosin comprises a % PAN from about 50 to about 75%, from about 55 to about 75%, from about 60 to about 75%, from about 65 to about 75%, from about 70 to about 75%, from about 50 to about 70%, from about 55 to about 70%, from about 60 to about 70%, from about 65 to about 70%, from about 50 to about 65%, from about 55 to about 65%, from about 60 to about 65%, from about 50 to about 60%, from about 50 to about 55%, or from about 55 to about 60%.

In certain embodiments, the enrichment in palustric acid, abietic acid, and neoabietic acid is indicated by the ratio of abietic acid to dehydroabietic acid. In certain embodiments, the purified rosin comprises an abietic acid to dehydroabietic acid ratio from about 1.5 to about 3.0, from about 1.8 to about 3.0, from about 2.0 to about 3.0, or from about 2.5 to about 3.0. In additional embodiments, the purified rosin comprises a lower percentage of dehydroabietic acid than rosin that is not purified and/or rosin that was not purified by the disclosed methods. In certain embodiments, the purified rosin comprises a percentage of dehydroabietic acid of less than about 25%, or less than about 20%, as determined by gas chromatography-mass spectroscopy (GC-MS).

The disclosed methods reduce or eliminate the dimer and/or higher molecular weight components, for example, fatty acid trimers and tetramers. The presence of dimer and/or higher molecular weight components can be indicated by the acid content. The higher the acid content, the lower the amount of dimer and/or higher molecular weight components present. As such, in certain embodiments, the purified rosin comprises an acid content from about 96 to about 100%, from about 97 to about 100%, from about 98 to about 100%, from about 99 to about 100%, from about 99.1 to about 100%, from about 99.2 to about 100%, from about 99.3 to about 100%, from about 99.4 to about 100%, or from about 99.5 to about 100%. In certain embodiments, the purified rosin can have an acid content of 100%.

The disclosed methods advantageously provide high recovery yields of purified rosin acids. High recovery yields from a purification step are particularly desirable on an industrial scale. The recovery yield is calculated by dividing the weight of purified rosin by the weight of starting material (e.g., TOR). In certain embodiments, the amount of purified rosin recovered comprises from about 50 to about 100%, from about 55 to about 100%, from about 60 to about 100%, from about 75 to about 100%, from about 60 to about 90%, from about 65 to about 90%, from about 70 to about 90%, from about 75 to about 90%, from about 55 to about 85%, from about 60 to about 85%, from about 65 to about 85%, from about 70 to about 85%, or from about 75 to about 85%.

In another aspect, the description provides a purified rosin prepared according to the methods described herein. In any of the aspects or embodiments, the purified rosin has the features as described herein.

The purified rosins obtained according to the methods described herein can be used to provide modified rosins. Accordingly, in an additional aspect, the description provides rosin derivatives including rosin esters, disproportionated rosins, hydrogenated rosins, dimerized rosins and combinations thereof. In certain embodiments, rosin esters comprise rosin esters of glycerol, pentaerythritol, diethylene glycol, triethylene glycol, sorbitol, neopentylglycol, trimethylolpropane, methanol, ethanol, butanol, 2-ethyl hexanol, or C₈₋₁₁ alcohols. In certain embodiments, the rosin ester is an ester of pentaerythritol.

In certain embodiments, modified rosins obtained from rosin acids purified by the disclosed methods comprise improved properties in comparison to modified resins obtained from rosin acids that have not been purified and/or have not been purified according to the disclosed methods. Modified rosins can be obtained by subjecting a purified rosin to at least one of several reactions, such as esterification, amide formation, disproportionation, hydrogenation and/or a dimerization by any known or suitable methods.

In certain embodiments, modified rosins obtained from rosins purified by the disclosed methods comprise a Gardner color (neat or 1:1 in toluene) determined according to ASTM D1544-04 (2010) up to about 5.0, from about 1.0 to about 4.5, from about 1.0 to about 4.0, from about 1.0 to about 3.5, from about 1.0 to about 3.3, from about 1.0 to about 2.0, from about 1.5 to about 4.0, from about 1.5 to about 3.5, from about 1.5 to about 3.0, from about 1.5 to about 2.5, from about 1.5 to about 2.0, from about 2.0 to about 4.0, from about 2.5 to about 4.0, from about 3.0 to about 4.0, from about 3.5 to about 4.0, from about 3.0 to about 4.0, or from about 3.5 to about 4.0.

In further embodiments, modified rosins obtained from rosins purified by the disclosed methods comprise a higher softening point as compared with modified resins obtained from rosins not purified and/or rosins not purified by the disclosed methods. Non-limiting exemplary embodiments of modified resins include glycerol esters, ethylene glycol esters, and pentaerythritol esters. In certain embodiments, the softening point of an pentaerythritol ester obtained from a purified resin as described herein comprises can be greater than about 100° C., greater than about 105° C., preferably greater than about 110° C.

### EXAMPLES

In the examples below, the Gardner color was measured with a ColorQuest XT spectrophotometer (HunterLab) using ASTM D1544-04 (2010). The softening point was measured by a Mettler DP 90 dropping point analyzer using ASTM D6090. The acid number was measured by a Metrohm auto-titrator with KOH solution by ASTM D664. Sulfur content was measured by XRF.

GC-MS was used for component identification. Samples were prepared by weighing about 0.5 g of sample into a 4 ml vial and dissolving in 4 ml of 50:50 methanol/ether (v/v). Samples were derivatized with trimethylphenylammonium hydroxide (TMPAH). An aliquot was transferred to an auto sampler vial, and the vial was loaded onto the auto sampler for analysis.

The instrument parameters were as follows.

Instrument: Shimadzu GCMS-QP2010 SE

Column: SP2380, 30 m, 0.25 mm ID, 0.2 μm

Diluent: 50:50 MeOH: ether

Injection Volume: 1 μL pulsed split 1:50

Injection Temperature: 330° C.

Oven Temperature: 150° C. (hold 5 min) to 250° C. (hold 7 min) at 10° C./min

Carrier Gas: Helium, constant flow

Flow Rate: 1.2 mL/min

Transfer Line Temperature: 275° C.

Analyzer Type: Quadrupole

Source Temperature: 240° C.

Quad Temperature: 150° C.

Solvent Delay: 2.0 min

Samples were analyzed by WATERS GPC equipped with a 2707 Autosampler and 2414 Refractive Index Detector. Data acquisition and handling were made with BREEZE 2 software.

Data were obtained under the following conditions:

| Solvent | THF | |
|---|---|---|
| Flow Rate | 1.0 | mL/min |
| Injection Volume | 25 | μL |
| Column Temperature | 40 | ° C. |
| Concentration | ~10 | mg/mL |
| Column | 1 × Ultrastyragel 500 Å 7.8 × 300 mm 10571 | |
| | (100-10K), | |
| | 2 × Ultrastyragel 100 Å 7.8 × 300 mm 10570 | |
| | (100-5K) | |
| Run Time | 35 | Minutes |

The details of the examples are contemplated as further embodiments of the described methods and compositions. Therefore, the details as set forth herein are hereby incorporated into the detailed description as alternative embodiments.

### Example 1A. Purification of a Tall Oil Rosin

1780 g rosin SSA (Ingevity, South Carolina) was dissolved in 1500 g isopropanol in a 10-liter beaker (heated to 80° C.) until the solution became clear. Then to the solution was added a total of 3000 g acetonitrile (including washing the filter cake). The solution was removed from the heating source and allowed to cool to room temperature.

After 1 hour at room temperature, a white precipitate formed that was collected by gravity filtration followed by vacuum filtration. The resulting filter cake was washed with additional acetonitrile until the filtrate had no more yellow tint. The white powder was dried in the air overnight and the results are summarized in Table 1. The percent recovery was about 55%.

### Example 1B. Purification of Tall Oil Rosin

To a 3 L round bottom flask was added 700 g of rosin SSA (Ingevity, South Carolinia). The solid was heated to 150° C. to melt and 212 g of n-butanol was added at a rate to avoid excessive foaming. The solution was cooled to approximately 120° C. during the addition. The solution was further cooled to approximately 100° C. and 1100 g of acetonitrile was added at a rate of 16 g/min allowing the suspension to cool to 80° C. during the addition of the acetonitrile. After 110 g of acetonitrile was added, the solution was seeded with 1 g of purified rosin crystals. Once the addition of the acetonitrile was complete, the temperature was reduced to 65° C. After holding at 65° C. for approximately 1 h, the suspension was slowly cooled to 10-12° C. and stirred for approximately 1 h. The solid was isolated via filtration and the resultant cake was washed with 850 g of acetonitrile. The solid was partially dried on the filter and then further dried under vacuum at 60° C. to afford 527 g (75% yield) of an off-white solid.

TABLE 1
Purified rosin properties

| | Acid | Gardner | Gardner | Softening | Sulfur |
|---|---|---|---|---|---|
| | Number | Color (1/1 | Color | Point | content |
| | (mgKOH/g) | in toluene) | (neat) | (° C.) | (ppm) |
| INGEVITY | 173.4 | 5.1 | 6.5 | 75.6 | 600 |
| rosin SSA | | | | | |
| Purified rosin | 180.3 | 2.1 | 3.3 | 94.5 | 356 |
| Example 1A | | | | (dropping | |
| | | | | point) | |
| Purified rosin | 178 | 2.3 | 3.9 | >100 | 120 |
| Example 1B | | | | (dropping | |
| | | | | point) | |

GC-MS analysis of the purified rosin revealed that significant changes in isomer distribution (Table 2):

TABLE 2
GC-MS results

| | | Purified | Purified |
|---|---|---|---|
| | Rosin SSA | Example 1A | Example 1B |
| % PAN* | 49.09 | 61.01 | 52 |
| % Palustric | 6.83 | 7.1 | 6.8 |
| % Abietic | 40.18 | 52.49 | 43.64 |
| % Neoabietic | 2.08 | 1.71 | 1.56 |
| % Dehydroabietic | 27.44 | 18.7 | 21.63 |
| Abietic/dehydroabietic | 1.46 | 2.81 | 2.02 |
| ratio | | | |

*“PAN” represents the total sum of the rosin acids: palustric acid, abietic acid, and neoabietic acid.

The GPC analysis, which highlights the dimer or higher and rosin acid content is listed below in Table 3:

TABLE 3
GPC results

| | Rosin SSA | Example 1A | Example 1B |
|---|---|---|---|
| Fatty acid dimers | 4.24 | 0 | 0 |
| or higher molecular | | | |
| weight material % | | | |
| Rosin acid % | 95.76 | 100.00 | 98.5 |
| Peak molecular weight | 301 | 298 | 307 |

### Example 2. Pentaerythritol Ester of the Purified Rosin

800 g the purified rosin from Example 1A was added to a two-liter reactor fitted with an overhead stirrer, nitrogen inlet and Dean-Stark trap and heated to 180° C. under nitrogen atmosphere. When rosin became molten, stirring was initiated. When the batch reached 180° C., 3.7 g BNX-1425, 2.4 g Rosinox, and 83 g mono-PE (Pentaerythritol) were added to the reaction mixture. The reactor was heated to 260° C. and nitrogen sparging was initiated at 5 ml/min. When the temperature reached 260° C., sparging was increased to 20 ml/min.

Samples were taken along the process to monitor acid number change along with color and softening point. The reaction was stopped when acid number dropped below 15. The progress is summarized in Table 4.

TABLE 4
Reaction progress for pentaerythritol ester of the purified rosin

| Reaction time at | Gardner Color | | |
|---|---|---|---|
| 260° C. (hours) | (neat) | Acid number | Softening point |
| 8 | 1.9 | 39.7 | |
| 10 | 1.9 | 28.4 | 108.1 |
| 11.5 | 1.8 | 23.7 | 109.9 |
| 14 | 1.8 | 18.7 | 112.1 |
| 18 | 1.9 | 9.3 | 114.2 |

Using the method described above, the pentaerythritol ester obtained from a non-purified distilled tall oil rosin had a Gardner color of at least 4 and a softening point of about 100° C.

With the purified rosin as starting material, the pentaerythritol ester of rosin had much lower color (1.9) and higher softening point (114° C.). This could benefit many applications that require such properties.

### Example 3. Solvent Reuse for Tall Oil Rosin Purification

The filtrate collected from Example 1A was distilled on a rotary evaporator to obtain solvent mixture for reuse.

Thus, 260 g of the recycled isopropanol and acetonitrile mixture was added to a 500 ml beaker and 80 g fresh Rosin SSA (distilled rosin) was dissolved in this solvent mixture and heated to 80° C. After all rosin was dissolved and the solution was clear, the solution was cooled to room temperature with slow agitation. After 2 h at room temperature, the white precipitate was isolated by filtration. The filter cake was washed with an additional 30 g acetonitrile and the white powder was dried in a vacuum oven for 2 h at 50° C. and 20 mmHg.

The acid number, softening point and color were consistent after three batches of reuse of the solvents (Table 5).

TABLE 5
'urified rosin properties with solvent reuse

| | Acid | Gardner | |
|---|---|---|---|
| | Number | Color (1/1 | Softening Point |
| | (mgKOH/g) | in toluene) | (DP90) (° C.) |
| Purified rosin | 180.3 | 2.1 | 94.5 |
| batch 1 | | | |
| Purified rosin | 181.5 | 2.2 | 89.9 |
| batch 2 | | | |
| Purified rosin | 181.7 | 1.8 | 96.7 |
| batch 3 | | | |

The results indicate that reuse of solvent does not adversely impact the quality of the purified rosin. The acid number, color, and softening point were consistent batch to batch.

While several embodiments of the invention have been shown and described herein, it will be understood that such embodiments are provided by way of example only. Numerous variations, changes and substitutions will occur to those skilled in the art without departing from the spirit of the invention. Rather, the present disclosure is to cover all modifications, equivalents, and alternatives falling within the scope of the present disclosure as defined by the following appended claims and their legal equivalents. Accordingly, it is intended that the description and appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients can be varied to optimize the desired effects, additional ingredients can be added, and/or similar ingredients can be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

What is claimed is:

1. A method for purification of a rosin comprising the steps of
a. admixing a rosin-containing composition and at least one first solvent;
b. heating the mixture to form a solution;
c. combining the solution with at least one second solvent;
d. cooling the solution from step (c); and
e. isolating a purified rosin precipitate,
wherein the purified rosin has at least one of: a Gardener color from about 1 to about 4 as measured according to ASTM D1544-04; a sulfur content of about 50 to about 500 ppm as measured according to X-ray fluorescence; an acid number equal to or greater than about 178 mg KOH/g according to ASTM D664, or a combination thereof.

2. The method of claim 1, wherein the first solvent is a rosin-favorable solvent, and the second solvent that is a rosin-unfavorable solvent.

3. The method of claim 1, wherein the first solvent to rosin-containing composition ratio is about 10:1 to about 1:1 by weight.

4. The method of claim 2, wherein the rosin-favorable solvent is at least one of an alcohol, chloroform, toluene, acetone, or a combination thereof.

5. The method of claim 2, wherein the rosin-unfavorable solvent is at least one of hexanes, petroleum ether, acetonitrile, benzonitrile, acrylonitrile, heptane, petroleum ether, or a combination thereof.

6. The method of claim 1, wherein the cooling step comprises cooling the mixture to a temperature of from about 30° C. to about −10° C.

7. The method of claim 1, wherein the yield of purified rosin is greater than 60%.

8. The method of claim 1, further comprising a drying step comprising air drying, oven drying, or a combination thereof.

9. The method of claim 1, wherein the purified rosin has at least one of: an acid content of from about 96 to about 100% as determined by gel permeation chromatography, a softening point of greater than about 85° C. according to ASTM 6090, or a combination thereof.

10. The method of claim 1, wherein the purified rosin has a percentage of palustric acid, a percentage of abietic acid, and a percentage of neoabietic acid, wherein the combined total of the percentages of palustric acid, abietic acid, and neoabietic acid is from about 50 to about 75% as determined by gas chromatography-mass spectroscopy.

11. The method of claim 1, wherein the purified rosin has a percentage of dehydroabietic acid of less than about 25% as determined by gas chromatography-mass spectroscopy.

12. The method of claim 1, wherein the purified rosin has a ratio of abietic acid to dehydroabietic acid of greater than about 1.5 as determined by gas chromatography-mass spectroscopy.

13. A method for purification of a rosin using recycled solvent comprising the steps of
a. admixing a rosin-containing composition and a recycled solvent;
b. heating the mixture to form a solution;
c. cooling the solution from step (b); and
d. isolating a purified rosin precipitate,
wherein the purified rosin has at least one of: a Gardener color from about 1 to about 4 as measured according to ASTM D1544-04; a sulfur content of about 50 to about 500 ppm as measured by X-ray fluorescence; an acid number of equal to or greater than about 178 mg KOH/g according to ASTM D664, or a combination thereof.

14. The method of claim 13, wherein the recycled solvent is a mixture of a first rosin-favorable solvent and a second rosin-unfavorable solvent.

15. The method of claim 14, wherein the rosin-favorable solvent is at least one of an alcohol, chloroform, toluene, acetone, or a combination thereof.

16. The method of claim 14, wherein the rosin-unfavorable solvent is at least one of hexanes, petroleum ether, acetonitrile, benzonitrile, acrylonitrile, heptane, petroleum ether, water, or a combination thereof.

17. The method of claim 13, wherein the purified rosin has at least one of: an acid content of about 96 to about 100% as determined by gel permeation chromatography; or a softening point of greater than about 85° C. according to ASTM 6090.

18. The method of claim 13, wherein the purified rosin has a percentage of palustric acid, abietic acid, and neoabietic acid, wherein the combined total of the percentages of palustric acid, abietic acid, and neoabietic acid are from about 50 to about 75% as determined by gas chromatography-mass spectroscopy.

19. The method of claim 13, wherein the purified rosin has a percentage of dehydroabietic acid of less than about 25% as determined by gas chromatography-mass spectroscopy.

20. The method of claim 13, further comprising a drying step comprising air drying, oven drying, or a combination thereof.
